(19) United States
(12) Patent Application Publication
(10) Pub. No.: US 2026/0270641 A1
(43) Pub. Date: Sep. 10, 2026

(54) GENERATION DEVICE, GENERATION METHOD, AND GENERATION PROGRAM

(71) Applicant: Sony Group Corporation, Tokyo (JP)

(72) Inventor: Koyuru Okimoto, Tokyo (JP)

(73) Assignee: Sony Group Corporation, Tokyo (JP)

(21) Appl. No.: 19/164,993

(22) PCT Filed: Mar. 19, 2024
(86) PCT No.: PCT/JP2024/010697

§ 371 Date: Sep. 12, 2025

(30) Foreign Application Priority Data
Mar. 30, 2023 (JP) 2023-056602

(51) Int. Cl. H04S 7/00; G10K 15/02

(52) U.S. Cl. CPC H04S 7/304; G10K 15/02; H04S 7/306; H04S 2400/01; H04S 2400/11

(57) ABSTRACT

To enable reproduction of a virtual sound source in consideration of an environment in which a user actually listens to a sound. A generation device includes an acquisition unit configured to acquire room shape information regarding a shape of a room; a setting unit configured to set positions of sound producing points and sound receiving points of a virtual sound source in the room based on the room shape information acquired by the acquisition unit; and a generation unit configured to generate a room impulse response in the room based on the positions of the sound producing points and the sound receiving points set by the setting unit and the room shape information.

### FIELD

The present invention relates to a generation device, a generation method, and a generation program.

### BACKGROUND

A binaural room impulse response (BRIR) is a mathematical representation of an acoustic transfer characteristic, which is a characteristic of how a sound reaches from a sound source to both ears in a sound field of a room, by a transfer function. The sound using the binaural room impulse response can stereoscopically reproduce a sound image by headphones or the like. The binaural room impulse response is divided into a room impulse response (RIR) and a head related impulse response (HRIR).

The room impulse response is a transfer function related to an environmental characteristic of a space of a room of a user, which is measured using microphones worn on the ears of the user (listener), a dummy head, or data of a head of a user himself/herself. In the room impulse response, the transfer function is represented by a time domain, and the transfer function is substantially synonymous with a room transfer function (RTF) represented by a frequency domain. The room impulse response represents an influence of a room out of the binaural room impulse response.

The head related impulse response is a transfer function related to an auditory characteristic of a user, in which binaural signal processing is performed using a dummy head (HATS: Head and Torso Simulators), a head of a user himself/herself, or the like. In the head related impulse response, a transfer function is represented by a time domain, and the transfer function is substantially synonymous with a head-related transfer function (HRTF) represented by a frequency domain. The head related impulse response represents an influence of a shape of a head of a user out of the binaural room impulse response, and the effect is enhanced by using the head-related transfer function of the user (see, for example, Patent Literatures 1 to 3).

In reproduction of headphones subjected to the binaural signal processing, the binaural room impulse response as a parameter for the binaural signal processing has been conventionally provided by the following methods.
A general binaural room impulse response (for example, an average one such as a dummy head, and the like)
A method of selecting from several options
A method of optimizing for a user using acoustic measurement
A method of optimizing for a user using ear image information, face image information, and the like

In a listening room in which a multichannel speaker such as 5.1ch is placed, it is known that a highly effective virtual sound source is reproduced by acquiring a binaural room impulse response of a user himself/herself by microphones worn on both ears of the user, adding the binaural room impulse response to a 5.1ch source, and reproducing the binaural room impulse response with the headphones. When looking closely at the state, it can be seen that the room impulse response in the listening room is reproduced with high accuracy in addition to reproducing the head related impulse response of the user himself/herself.

For example, when a sound of a speaker system installed in the listening room is compared with a sound of the headphones reflecting the binaural room impulse response, both sounds are felt to have the same quality. That is, the sound of the listening room can be reproduced in other places through the headphones. For example, when the sound is reproduced through the headphones in a living room at a home of a user, it is possible to reproduce a virtual sound source in a state of enjoying a movie or a game in the listening room where measurement has been performed.

### CITATION LIST

### Patent Literature

Patent Literature 1: JP 2022-107790 A
Patent Literature 2: JP 2022-504516 A
Patent Literature 3: JP 2021-175043 A

### SUMMARY

### Technical Problem

However, in the conventional techniques as described above, there is a case where it is not possible to reproduce a virtual sound source in consideration of an environment in which a user actually listens to the sound. As an example, since a space (for example, a living room) in which the user himself/herself is present and a space (for example, a listening room where measurement has been performed) where the sound is provided through the headphones are different from each other, a difference in feeling occurs, with the space being wider or narrower than the place in which the user himself/herself is present, which may cause the user to feel uncomfortable. One aspect of the present disclosure enables reproduction of a virtual sound source in consideration of an environment in which a user actually listens to a sound.

### Solution to Problem

A generation device according to an embodiment of the present disclosure includes: an acquisition unit configured to acquire room shape information regarding a shape of a room; a setting unit configured to set positions of sound producing points and sound receiving points of a virtual sound source in the room based on the room shape information acquired by the acquisition unit; and a generation unit configured to generate a room impulse response in the room based on the positions of the sound producing points and the sound receiving points set by the setting unit and the room shape information.

A generation method according to an embodiment of the present disclosure, executed by a generation device, includes: an acquisition step of acquiring room shape information regarding a shape of a room; a setting step of setting positions of sound producing points and sound receiving points of a virtual sound source in the room based on the room shape information acquired in the acquisition step; and a generation step of generating a room impulse response in the room based on the positions of the sound producing points and the sound receiving points set in the setting step and the room shape information.

A generation program according to an embodiment of the present disclosure causes a computer mounted on a generation device to execute: acquisition processing of acquiring room shape information regarding a shape of a room; setting processing of setting positions of sound producing points and sound receiving points of a virtual sound source in the room based on the room shape information acquired by the acquisition processing; and generation processing of generating a room impulse response in the room based on the positions of the sound producing points and the sound receiving points set by the setting processing and the room shape information.

### BRIEF DESCRIPTION OF DRAWINGS

FIG. 1 is a diagram for describing a room impulse response and a head related impulse response.

FIG. 2 is a diagram illustrating an example of a schematic configuration of a generation system according to an embodiment.

FIG. 3 is a diagram for describing outlines of a conventional technique and the generation system.

FIG. 4 is a diagram illustrating an example of setting of positions of sound producing points and sound receiving points.

FIG. 5 is a diagram illustrating an example of setting of positions of sound producing points and sound receiving points.

FIG. 6 is a diagram illustrating an example of setting of positions of sound producing points and sound receiving points.

FIG. 7 is a diagram illustrating an example of setting of positions of sound producing points and sound receiving points.

FIG. 8 is a diagram illustrating an example of setting of positions of sound producing points and sound receiving points.

FIG. 9 is a diagram illustrating an example of setting of positions of sound producing points and sound receiving points.

FIG. 10 is a diagram illustrating an example of setting of positions of sound producing points and sound receiving points.

FIG. 11 is a diagram illustrating an example of setting of positions of sound producing points and sound receiving points.

FIG. 12 is a diagram illustrating an example of setting of positions of sound producing points and sound receiving points.

FIG. 13 is a diagram illustrating an example of setting of positions of sound producing points and a sound receiving point.

FIG. 14 is a diagram illustrating an example of setting of positions of sound producing points and sound receiving points.

FIG. 15 is a diagram illustrating an example of setting of positions of a sound source and listening points.

FIG. 16 is a diagram illustrating an example of a configuration of a synthesis unit.

FIG. 17 is a flowchart illustrating an example of room impulse response generation processing and head related impulse response generation processing.

FIG. 18 is a flowchart illustrating an example of room impulse response generation processing.

FIG. 19 is a flowchart illustrating an example of head related impulse response generation processing.

FIG. 20 is a diagram illustrating an example of a schematic configuration of a generation system according to a modification.

FIG. 21 is a diagram illustrating an example of a hardware configuration of a device.

### DESCRIPTION OF EMBODIMENTS

Hereinafter, an embodiment of the present disclosure will be described in detail with reference to the drawings. In the following embodiment, the same elements are denoted by the same reference numerals, and redundant description may be omitted.

The present disclosure will be described according to the following order of items.
0. Introduction
1. Embodiment
2. Modification
3. Example of Hardware Configuration
4. Example of Effects

### 0. Introduction

As described above, a binaural room impulse response (BRIR) is a mathematical representation of an acoustic transfer characteristic which is a characteristic of how a sound reaches from a sound source to both ears in a sound field of a room, by a transfer function. The binaural room impulse response is divided into a room impulse response (RIR) and a head related impulse response (HRIR).

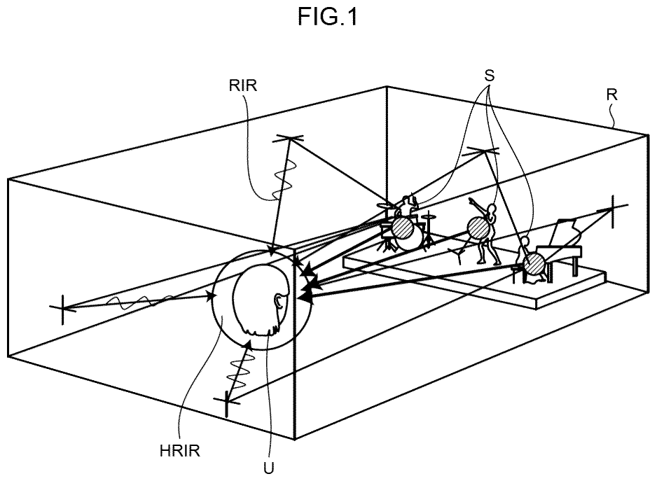

Hereinafter, a room impulse response and a head related impulse response will be described in detail with reference to FIG. 1. FIG. 1 is a diagram for describing a room impulse response and a head related impulse response. As illustrated in FIG. 1, the room impulse response RIR is a response in consideration of an influence of a room R out of the binaural room impulse response BRIR which is a characteristic of how a sound reaches from a sound source S to both ears of a user (listener) U in the room R. Examples of the influence of the room R include reflection of a wall which is a boundary between the room R and an exterior as illustrated in FIG. 1.

As illustrated in FIG. 1, the head related impulse response HRIR represents an influence of the user U in a spherical region in a predetermined range from the user U out of the binaural room impulse response BRIR which is a characteristic of how a sound reaches from the sound source S to both ears of the user U in the room R. The head related impulse response HRIR represents the influence of the user U out of the binaural room impulse response BRIR, and the effect is enhanced by using a head-related transfer function of the user U himself/herself (see, for example, Patent Literatures 1 to 3).

In the conventional techniques such as Patent Literatures 1 to 3, there is no description of converting room shape information into a sound or generating a room impulse response based on the room shape information. That is, in the conventional techniques as described above, an environment in which a user actually listens to a sound is not considered.

For this reason, in the conventional techniques as described above, there is a case where it is difficult to reproduce a virtual sound source in consideration of an environment in which a user actually listens to a sound. As an example, in the conventional techniques as described above, since a space (for example, a living room) in which the user himself/herself is present and a space (for example, a listening room where measurement has been performed) where the sound is provided through the headphones are different from each other, a difference in feeling occurs, with the space being wider or narrower than the place in which the user himself/herself is present, which may cause the user to feel uncomfortable.

According to the disclosed techniques, it is possible to reproduce a virtual sound source in consideration of an environment in which a user actually listens to the sound. Specific techniques are described in the following embodiment.

### 1. Embodiment

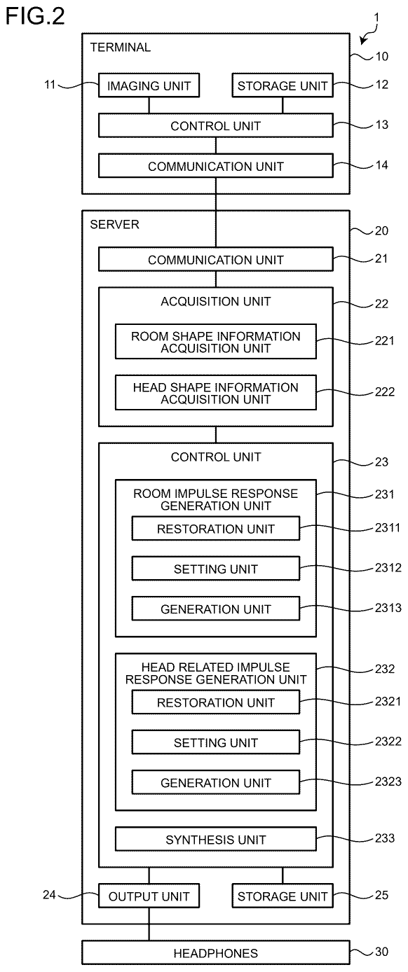

FIG. 2 is a diagram illustrating an example of a schematic configuration of a generation system according to the embodiment. A generation system 1 acquires room shape information, sets positions of sound producing points and sound receiving points of a virtual sound source in a room based on the room shape information, and generates a room impulse response in the room based on the positions of the sound producing points and the sound receiving points and the room shape information.

Here, the room shape information is information regarding a shape of a room. The room shape information is not particularly limited as long as it is information regarding a shape of a room in which positions of sound producing points and sound receiving points of a virtual sound source can be set based on the room shape information and a room impulse response can be generated. The room shape information may be, for example, plan view information in which a room is two-dimensionally represented, room imaging information in which a room is imaged, or three-dimensional diagram information in which a room is three-dimensionally represented.

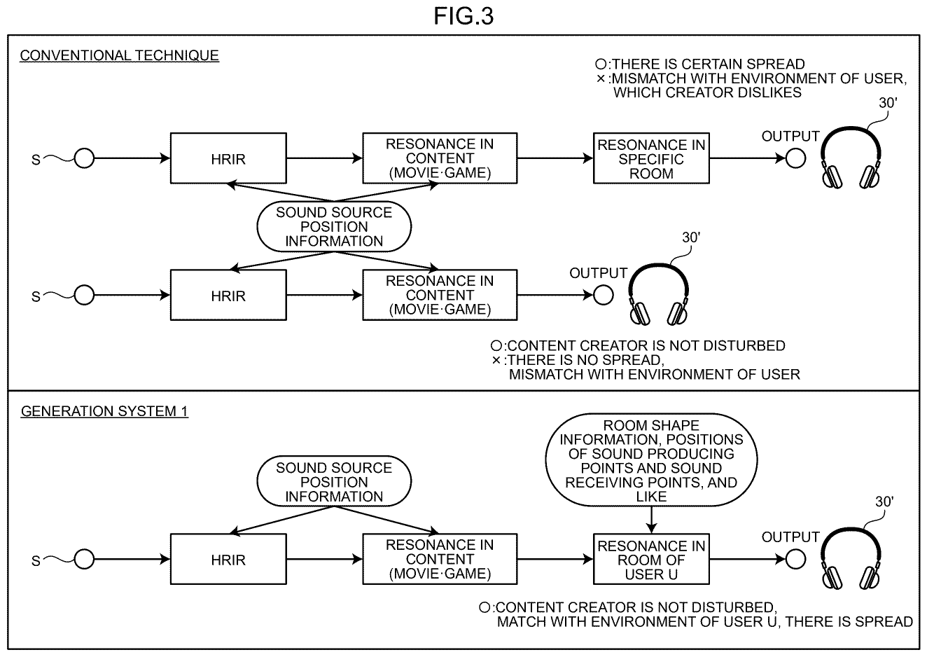

First, an outline of the generation system 1 will be described with reference to FIG. 3 while being compared with the conventional technique. FIG. 3 is a diagram for describing outlines of the conventional technique and the generation system.

As illustrated in an upper diagram of the conventional technique in FIG. 3, the conventional technique generates a head related impulse response HRIR based on sound source position information regarding a position of a sound source S. In the conventional technique, a resonance in a content such as a movie or a game based on the head related impulse response HRIR and the sound source position information and a resonance in a specific room are output to an output device such as headphones 30′. In this case, there is an advantage that there is a certain spread of sound, but there is a disadvantage that there is a mismatch with the environment of the user and the resonance in the specific room is added, which a content creator dislikes.

In addition, as illustrated in a lower diagram of the conventional technique in FIG. 3, the conventional technique generates the head related impulse response HRIR based on the sound source position information regarding the position of the sound source S. Then, in the conventional technique, the resonance in the content such as a movie or a game based on the head related impulse response HRIR and the sound source position information is output to the output device such as the headphones 30′. In this case, there is an advantage that the content creator is not disturbed, but there is a disadvantage that there is no spread of sound and there is a mismatch with the environment of the user.

On the other hand, as illustrated in the diagram of the generation system 1 in FIG. 3, the generation system 1 generates the head related impulse response HRIR based on the sound source position information regarding the position of the sound source S. Then, the generation system 1 outputs the resonance in the content such as a movie or a game based on the head related impulse response HRIR and the sound source position information, and the resonance in the room of the user U based on the room shape information and the room impulse response RIR generated based on the sound producing point and the sound receiving point of the sound source S to the output device such as headphones 30. As a result, since the generation system 1 can reproduce the sound according to the space or the environment, which is the room where the user U himself/herself exists, in addition to the sound in the content such as a movie or a game, there is an advantage that the content creator is not disturbed, the sound matches the environment of the user U, and there is a spread of sound.

Next, a configuration of the generation system 1 will be described with reference to FIG. 2. As illustrated in FIG. 2, the generation system 1 includes a terminal 10, a server (generation device) 20, and the headphones 30.

The terminal 10 images a room and a head of the user, and acquires room imaging information and head imaging information. The room imaging information refers to still image information or moving image information obtained by imaging the room. The head imaging information refers to still image information or moving image information obtained by imaging the head of the user including the shape of ears of the user, and may further include information obtained by imaging a face of the user. Examples of the terminal 10 include a smartphone and a game console. As illustrated in FIG. 2, the terminal 10 includes an imaging unit 11, a storage unit 12, a control unit 13, and a communication unit 14.

The imaging unit 11 images the room to acquire room imaging information, and images the head of the user including the ears of the user to acquire head imaging information. The imaging unit 11 may further acquire user imaging information including an entire body of the user. Examples of the imaging unit 11 include a camera and the like.

The storage unit 12 stores various types of information such as room imaging information, room shape information, head imaging information, head shape information, reflectance information, width information, and size information. The head shape information refers to information regarding the head of the user including the shape of the ears of the user. Examples of the head shape information include a feature amount of an auricle acquired from ear image information regarding the image of the ears such as ear imaging information in which the ears of the user are imaged, and a feature amount such as a shape of the face of the user acquired from the face image information regarding the image of the face such as face imaging information in which the face of the user is imaged. The reflectance information refers to information regarding a reflectance of a boundary between a room and an exterior, and may include material information regarding a material of the room. For example, the reflectance information includes material information regarding a material such as a material of a wall that is the boundary between the room and the exterior. The width information refers to information regarding a width of the room. The size information refers to information regarding a size of a body of the user. Examples of the size information include height information regarding a height of the user. Examples of the storage unit 12 include a storage device such as a hard disk drive (HDD), a solid state drive (SSD), and an optical disk, and a semiconductor memory capable of rewriting data, such as a random access memory (RAM), a flash memory, and a non-volatile static random access memory (NVSRAM). The storage unit 12 stores an operating system (OS) and various programs executed by the terminal 10.

The control unit 13 controls the entire terminal 10. The control unit 13 includes, for example, one or more processors having a program defining each processing procedure and an internal memory storing control data, and the processor executes each processing using the program and the internal memory. Examples of the control unit 13 include electronic circuits such as a central processing unit (CPU), a micro processing unit (MPU), and a graphics processing unit (GPU), and integrated circuits such as an application specific integrated circuit (ASIC) and a field programmable gate array (FPGA).

The communication unit 14 communicates with the server 20, more specifically, a communication unit 21 of the server 20 via a telecommunication line such as a local area network (LAN) or the Internet. For example, the communication unit 14 transmits various types of information such as room imaging information, room shape information, head imaging information, head shape information, reflectance information, width information, and size information to the communication unit 21 of the server 20. Examples of the communication unit 14 include a network interface card (NIC) and the like.

The server 20 is a generation device that acquires room shape information, sets positions of sound producing points and sound receiving points of a virtual sound source in the room based on the room shape information, and generates a room impulse response in the room based on the positions of the sound producing points and the sound receiving points and the room shape information. Examples of the server 20 include a game console and the like. As illustrated in FIG. 2, the server 20 includes the communication unit 21, an acquisition unit 22, a control unit 23, an output unit 24, and a storage unit 25.

The communication unit 21 communicates with the terminal 10, specifically, the communication unit 14 of the terminal 10 via a telecommunication line such as a LAN or the Internet. For example, the communication unit 21 receives various types of information such as room imaging information, room shape information, head imaging information, head shape information, reflectance information, width information, and size information from the communication unit 14 of the terminal 10. Examples of the communication unit 21 include an NIC and the like.

The acquisition unit 22 acquires various types of information such as room shape information from the communication unit 14 of the terminal 10 via the communication unit 21. As illustrated in FIG. 2, the acquisition unit 22 includes a room shape information acquisition unit (acquisition unit) 221 and a head shape information acquisition unit 222.

The room shape information acquisition unit 221 acquires room shape information, which is primary information serving as a source of the room impulse response. In the example illustrated in FIG. 2, the room shape information acquisition unit 221 further acquires room imaging information. The room shape information acquisition unit 221 may acquire the room imaging information separately from the room shape information, or may acquire the room imaging information as the room shape information. In the example illustrated in FIG. 2, the room shape information acquisition unit 221 acquires the room imaging information, and a restoration unit 2311 to be described later restores the room shape information to the room shape information in which the room is three-dimensionally represented based on the room imaging information. However, the room shape information acquisition unit 221 may acquire, as the room shape information, the room shape information in which the room is three-dimensionally represented in advance. The room shape information acquisition unit 221 may acquire room shape information in which the room is represented as a plan view.

The room shape information acquisition unit 221 may further acquire at least one of reflectance information regarding a reflectance of the boundary between the room and the exterior, width information regarding the width of the room, and size information regarding the size of the body of the user. For example, the room shape information acquisition unit 221 may further acquire at least one of reflectance information including a reflection coefficient of the boundary between the room and the exterior, width information, and size information from the communication unit 14 of the terminal 10 via the communication unit 21. Further, the room shape information acquisition unit 221 may acquire reflectance information including material information regarding a material of the room. The reflectance information, the width information, and the size information may be set in advance manually by the user, or may be estimated based on still image information or moving image information such as room imaging information or user imaging information. In this case, a subject that estimates the reflectance information, the width information, and the size information based on the room imaging information, the user imaging information, and the like is not particularly limited. For example, the subject that estimates the reflectance information and the width information based on the room imaging information or the like may be the room shape information acquisition unit 221, the control unit 13 of the terminal 10, or the like. The subject that estimates the size information may be the room shape information acquisition unit 221, the control unit 13 of the terminal 10, the head shape information acquisition unit 222, or the like.

The head shape information acquisition unit 222 acquires head shape information, which is primary information serving as a source of the head related impulse response. In the example illustrated in FIG. 2, the head shape information acquisition unit 222 further acquires head imaging information. The head shape information acquisition unit 222 may acquire the head imaging information separately from the head shape information, or may acquire the head imaging information as the head shape information.

The head shape information acquisition unit 222 may acquire, instead of or in addition to the head imaging information, feedback information obtained by listening of the user from the communication unit 14 of the terminal 10 via the communication unit 21 as primary information serving as the source of the head related impulse response. The feedback information refers to information indicating a sound source selected as a sound source suitable for the user from among sound sources processed by a plurality of head related impulse responses.

The control unit 23 controls the entire server 20. The control unit 23 includes, for example, one or more processors having a program defining each processing procedure and an internal memory storing control data, and the processor executes each processing using the program and the internal memory. Examples of the control unit 13 include electronic circuits such as a CPU, an MPU, and a GPU, and integrated circuits such as an ASIC and an FPGA. As illustrated in FIG. 2, the control unit 23 includes a room impulse response generation unit 231 and a head related impulse response generation unit 232.

The room impulse response generation unit 231 generates a room impulse response based on the room shape information acquired by the room shape information acquisition unit 221. As illustrated in FIG. 2, the room impulse response generation unit 231 includes the restoration unit 2311, a setting unit 2312, and a generation unit 2313.

The restoration unit 2311 restores the room shape information to the room shape information in which the room is three-dimensionally represented based on the room imaging information acquired by the room shape information acquisition unit 221. For example, the restoration unit 2311 restores the room shape information including the room imaging information, the plan view information, and the like to the room shape information in which the room is three-dimensionally represented by a three-dimensional restoration technique such as light detection and ranging (LiDAR) or photogrammetry.

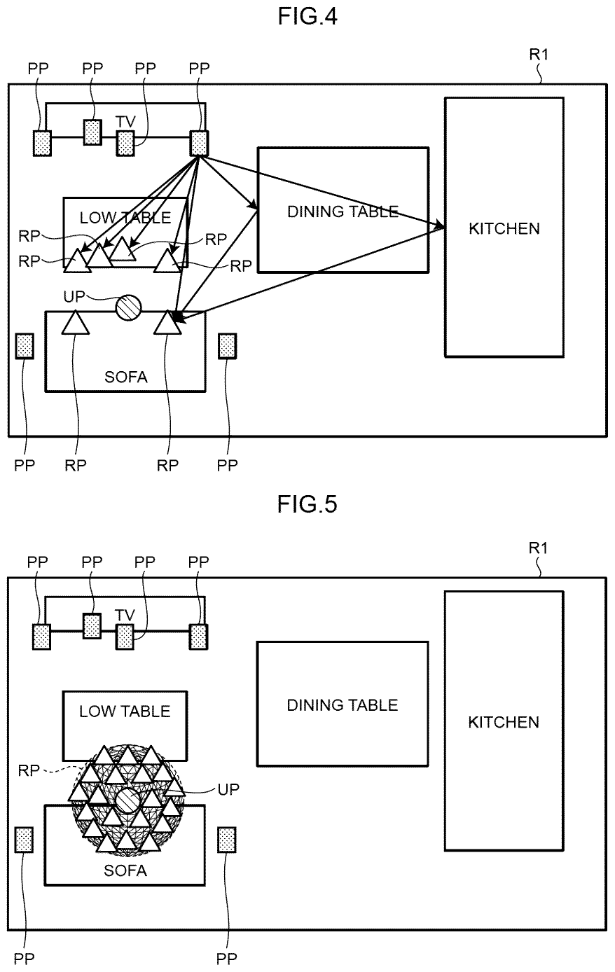

The setting unit 2312 sets positions of sound producing points and sound receiving points of a virtual sound source in the room based on the room shape information acquired by the room shape information acquisition unit 221. The setting unit 2312 may further set a position of the user. For example, the setting unit 2312 sets the positions of the sound producing points and the sound receiving points of the virtual sound source and the position of the user in a three-dimensional model or a plan view of the room, represented by the room shape information acquired by the room shape information acquisition unit 221 in the acquisition unit 22. The setting unit 2312 may further set directivity of the sound output from the virtual sound source. The setting unit 2312 may further set a distance attenuation rate of the sound output from the virtual sound source. Hereinafter, an example of setting of the positions of the sound producing points and the sound receiving points will be described with reference to FIGS. 4 to 14. FIGS. 4 to 14 are diagrams illustrating an example of the setting of the positions of the sound producing points and the sound receiving points.

First, an example of setting of the sound producing points and the sound receiving points by the setting unit 2312 will be described with reference to FIG. 4. In the example illustrated in FIG. 4, room shape information R1 is represented as a plan view of the room shape information three-dimensionally restored by the three-dimensional restoration technique of the restoration unit 2311 as viewed from a ceiling surface. The room represented by the room shape information R1 is a living room of a general home, and a television, a low table, a sofa, a kitchen, a dining table, and the like are arranged in the room.

In the example illustrated in FIG. 4, the setting unit 2312 sets a position UP of the user at a position near the center of the sofa facing the low table. The setting unit 2312 sets positions of sound producing points PP so as to achieve a 5.1ch speaker arrangement. The 5.1ch speaker arrangement refers to a speaker arrangement corresponding to 5.1ch. As an example, in the 5.1ch speaker arrangement, there is an arrangement in which an angle of the virtual sound source with respect to the position UP of the user is an angle of the 5.1ch speaker arrangement determined by the International Telecommunication Union Radiocommunication Sector (ITU-R), and a distance of the virtual sound source with respect to the position UP of the user is a distance of 1 m. Furthermore, the setting unit 2312 sets positions of sound receiving points RP at head related impulse response measurement positions corresponding to positions where the head related impulse response of the user is measured in an anechoic chamber. That is, the setting unit 2312 sets the positions of the sound receiving points RP so as to obtain an environment similar to a reference environment from which the HRIR is acquired.

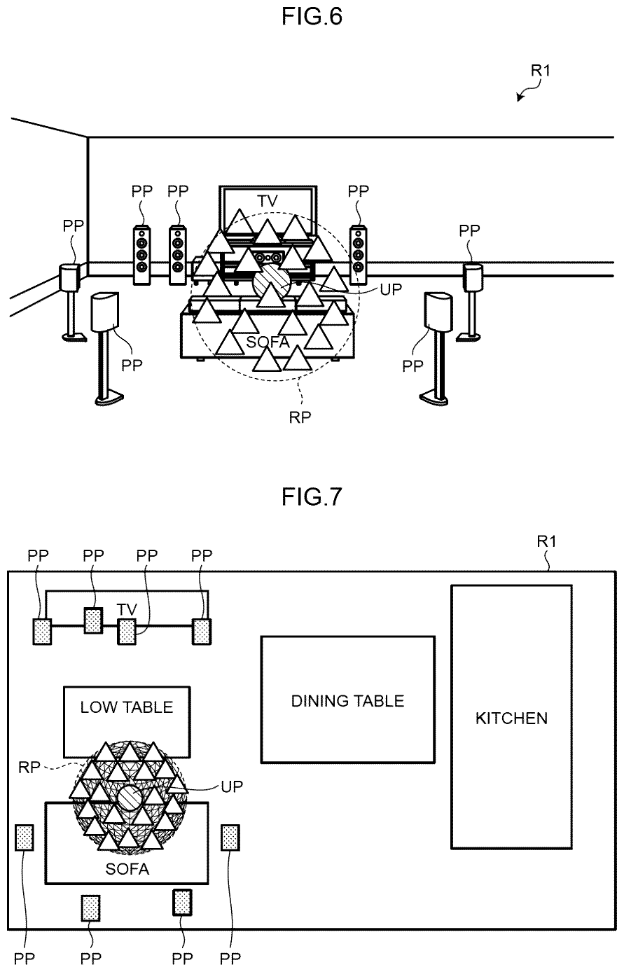

In the example illustrated in FIGS. 5 and 6, the setting unit 2312 sets the positions of the sound receiving points RP in all directions of the user instead of the positions of the sound receiving points RP illustrated in FIG. 4. That is, as illustrated in FIGS. 5 and 6, the setting unit 2312 sets the positions of the sound receiving points RP in all directions including a horizontal direction and a vertical direction with respect to the user, with the position of the user indicated by the position UP of the user as a center. In addition, in the example illustrated in FIGS. 5 and 6, the setting unit 2312 sets the positions of the sound receiving points RP such that a density of the sound receiving points RP is equal to or higher than a predetermined density. The setting unit 2312 sets the sound producing points PP and the position UP of the user similarly to FIG. 4, except for the sound receiving points RP.

In a case where the virtual sound source to be reproduced is a content produced by 7.1ch, the setting unit 2312 may set the positions of the sound producing points PP so as to achieve a 7.1ch speaker arrangement illustrated in FIG. 7 instead of the 5.1ch speaker arrangement illustrated in FIGS. 5 and 6. The 7.1ch speaker arrangement refers to an arrangement in which two back surround speakers are added in addition to the 5.1ch speaker. In the example illustrated in FIG. 7, the setting unit 2312 sets the sound receiving points RP and the position UP of the user similarly to FIGS. 5 and 6, except for the sound producing points PP.

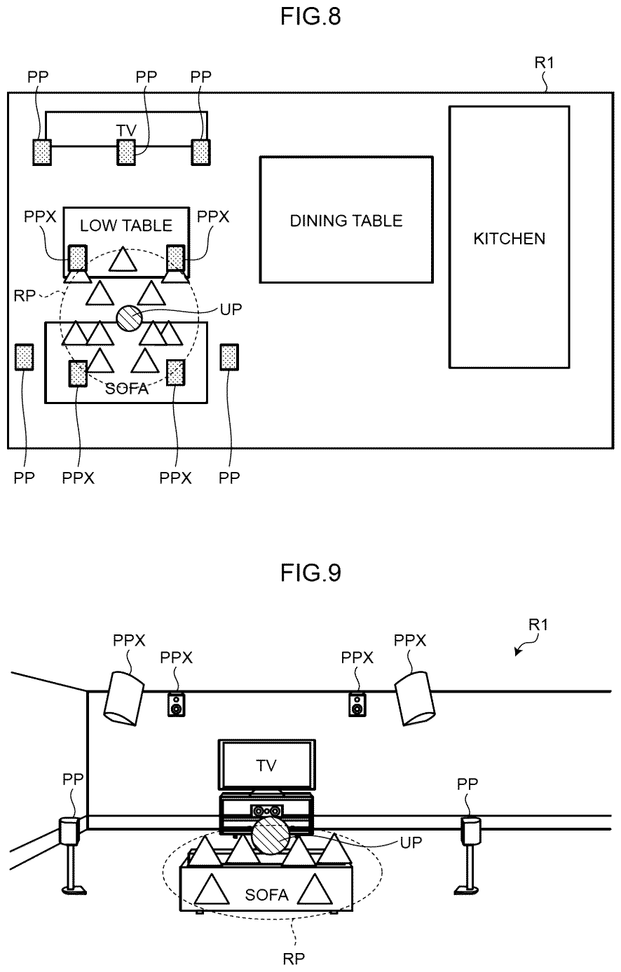

In the example illustrated in FIG. 8, the setting unit 2312 sets the positions of the sound producing points PP and sound producing points PPX so as to achieve a 7.1.4ch speaker arrangement. The 7.1.4ch speaker arrangement means a speaker arrangement corresponding to 7.1ch. As an example, in the 7.1ch speaker arrangement, there is an arrangement in which an angle of the virtual sound source with respect to the position UP of the user is an angle of the 7.1.4ch speaker arrangement determined by the ITU-R, and a distance of the virtual sound source with respect to the position UP of the user is 1 m. As is clear from the fact that the sound producing points PPX are ceiling speakers as illustrated in FIG. 9, the 7.1.4ch speaker arrangement is an arrangement assuming a virtual sound source including not only position information in the horizontal direction but also position information in the height direction.

In addition, the setting unit 2312 sets the positions of the sound receiving points RP at the head related impulse response measurement positions. That is, the setting unit 2312 sets the positions of the sound receiving points RP such that the environment is similar to the reference environment from which the HRIR is acquired. The setting unit 2312 sets the position UP of the user similarly to FIG. 4, except for the sound producing points PP and the sound receiving points RP.

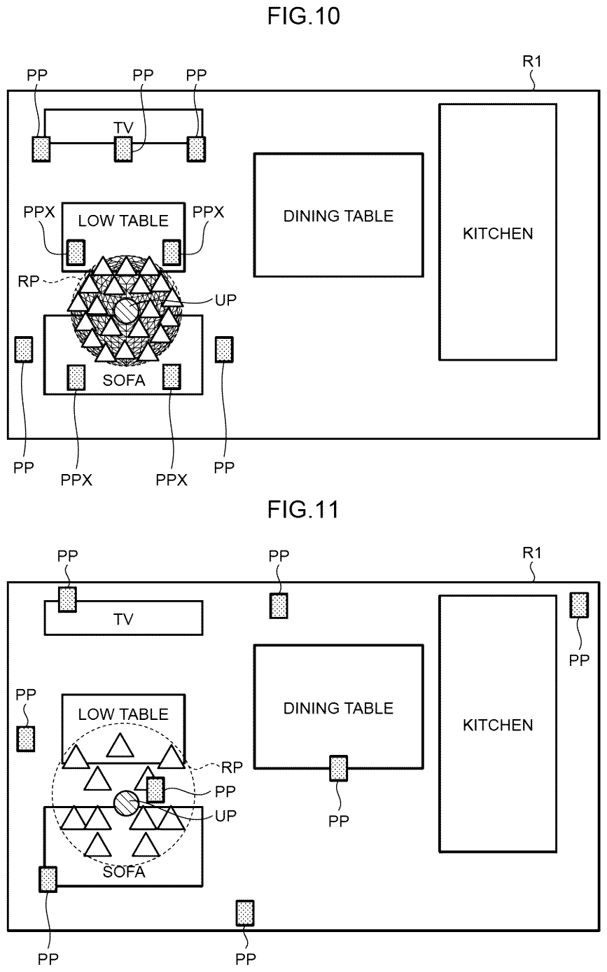

In the example illustrated in FIG. 10, the setting unit 2312 sets the positions of the sound receiving points RP in all directions of the user instead of the positions of the sound receiving points RP illustrated in FIGS. 8 and 9. That is, as illustrated in FIG. 10, the setting unit 2312 sets the positions of the sound receiving points RP in all directions including the horizontal direction and the vertical direction with respect to the user, with the position of the user indicated by the position UP of the user as a center. In addition, the setting unit 2312 sets a large number of positions of the sound receiving points RP such that the density of the sound receiving points RP is equal to or higher than a predetermined density. The setting unit 2312 sets the sound producing points PP, the sound producing points PPX, and the position UP of the user similarly to FIGS. 8 and 9, except for the sound receiving points RP.

In the example illustrated in FIG. 11, the setting unit 2312 sets the positions of the sound producing points PP at positions according to the content provided to the user together with the sound output from the virtual sound source. The positions according to the content refer to positions according to the content produced by adding the position information to the virtual sound source, such as an object sound source. The setting unit 2312 can set the positions according to the content to arbitrary positions, without any particular limitation as long as the position of the virtual sound source is within a computable range and is not incalculable, such as beyond the boundary of the room. For example, the setting unit 2312 sets a coordinate position itself of the virtual sound source defined in the content provided to the user together with the sound output from the virtual sound source such as a game or music as the position of the sound producing point PP.

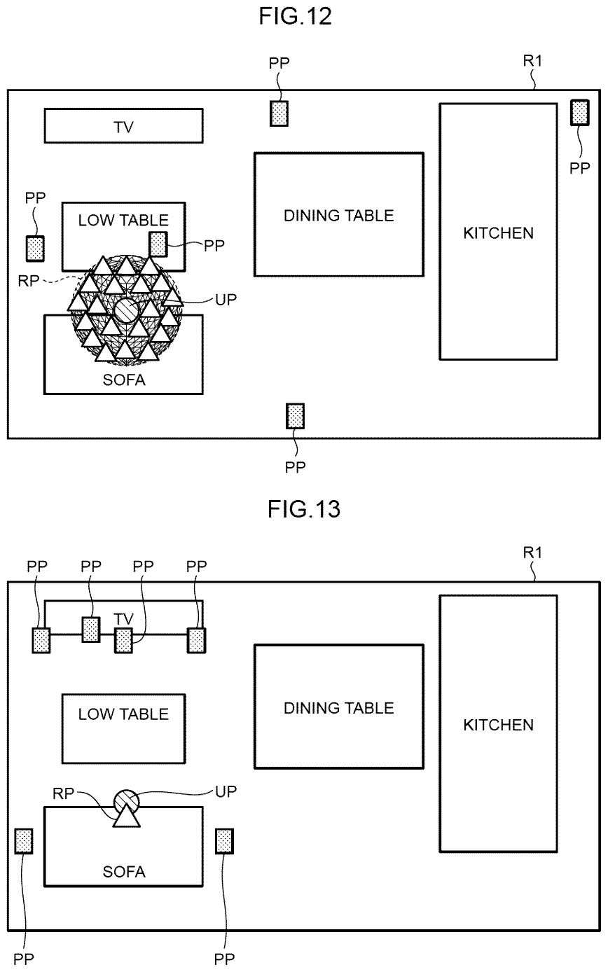

In the example illustrated in FIG. 12, the setting unit 2312 sets the positions of the sound receiving points RP in all directions of the user instead of the positions of the sound receiving points RP illustrated in FIG. 11. That is, as illustrated in FIG. 12, the setting unit 2312 sets the positions of the sound receiving points RP in all directions including the horizontal direction and the vertical direction with respect to the user, with the position of the user indicated by the position UP of the user as the center. In addition, the setting unit 2312 sets a large number of positions of the sound receiving points RP such that the density of the sound receiving points RP is equal to or higher than a predetermined density. The setting unit 2312 sets the sound producing points PP and the position UP of the user similarly to FIG. 11, except for the sound receiving points RP.

In the example illustrated in FIG. 4, the setting unit 2312 sets the positions of the sound receiving points RP at the head related impulse response measurement positions. However, as illustrated in FIG. 13, only one sound receiving point RP may be set. The setting unit 2312 sets the sound producing points PP and the position UP of the user similarly to FIG. 4, except for the sound receiving point RP.

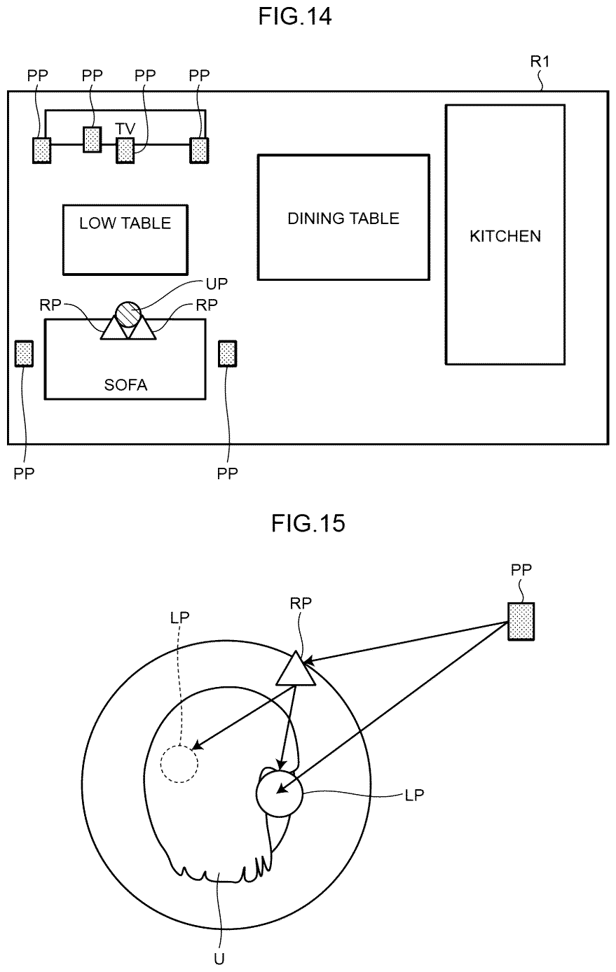

In the example illustrated in FIG. 13, the setting unit 2312 sets one sound receiving point RP, but may set two sound receiving points RP as illustrated in FIG. 14 in order to obtain a transmission path to both ears of the user more correctly. The setting unit 2312 sets the sound producing points PP and the position UP of the user similarly to FIG. 13, except for the sound receiving point RP.

The generation unit 2313 generates a room impulse response in the room based on the positions of the sound producing points and the sound receiving points set by the setting unit 2312 and the room shape information. The generation unit 2313 may generate the room impulse response further based on the information acquired by the room shape information acquisition unit 221 among the reflectance information, the width information, and the size information. The generation unit 2313 may generate the room impulse response further based on the position of the user set by the setting unit 2312. The generation unit 2313 may generate the room impulse response further based on the directivity of the sound output from the virtual sound source set by the setting unit 2312. Furthermore, the generation unit 2313 may generate the room impulse response further based on the distance attenuation rate of the sound output from the virtual sound source set by the setting unit 2312.

A method for generating the room impulse response by the generation unit 2313 is not particularly limited as long as the method is based on the positions of the sound producing points and the sound receiving points set by the setting unit 2312 and the room shape information. For example, the generation unit 2313 generates a room impulse response by: performing an acoustic simulation based on the positions of the sound producing points and the sound receiving points set by the setting unit 2312 and the room shape information; using a learned model in which a relationship between the positions of the sound producing points and the sound receiving points, the room shape information, and the room impulse response is learned, and the room impulse response is output in a case where the positions of the sound producing points and the sound receiving points and the room shape information are input; using a database in which the positions of the sound producing points and the sound receiving points, the room shape information, and the room impulse response are associated with each other; or directly performing acoustic measurement.

As an example, the generation unit 2313 generates a room impulse response based on the result of the acoustic simulation by performing the acoustic simulation based on the positions of the sound producing points and the sound receiving points set by the setting unit 2312 and the room shape information. In this case, the generation unit 2313 performs the acoustic simulation by using the sound producing points, the sound receiving points, and the position of the user set by the setting unit 2312, the directivity, the distance attenuation rate, and the room shape information and the reflectance information, which are the primary information serving as the source of the room impulse response acquired by the room shape information acquisition unit 221. For example, the generation unit 2313 performs the acoustic simulation assuming a case where the sound output from the virtual sound source installed at a position of a sound producing point is acquired at a position of a sound receiving point in a room indicated by room shape information or the like. Subsequently, the generation unit 2313 generates a room impulse response by converting these pieces of information into the room impulse response and making the room impulse response audible based on the result of the acoustic simulation.

The acoustic simulation is not particularly limited as long as a room impulse response from a sound producing point to a sound receiving point is generated based on the room shape information, the sound producing point, and the sound receiving point. Examples of the acoustic simulation for generating the room impulse response include wave acoustic analysis, geometric acoustic analysis, and analysis by hybrid thereof. The wave acoustic analysis is a method that considers sound propagation as wave propagation and analyzes a sound field by solving the wave equation. The geometric acoustic analysis is a method that considers sound propagation as propagation of energy particles and analyzes it geometrically. The analysis by hybrid means that these analyses are divided and used in combination for each frequency band.

As another example, the generation unit 2313 inputs the positions of the sound producing points and the sound receiving points set by the setting unit 2312 and the room shape information to a learned model in which the relationship between the positions of the sound producing points and the sound receiving points, the room shape information, and the room impulse response is learned, and the room impulse response is output in a case where the positions of the sound producing points and the sound receiving points and the room shape information are input, and generates the response output from the learned model as the room impulse response.

As another example, the generation unit 2313 generates a room impulse response by using a database in which positions of a plurality of sound producing points and sound receiving points set by the setting unit 2312, the room shape information, and a plurality of room impulse responses are associated with each other. In this case, first, the generation unit 2313 generates a database in which the positions of the plurality of sound producing points and sound receiving points set by the setting unit 2312, the room shape information, and the plurality of room impulse responses are associated with each other. Next, the generation unit 2313 generates a room impulse response based on feedback information from the user among the plurality of room impulse responses in the database obtained by listening of the user. For example, the generation unit 2313 generates a room impulse response to be recommended that is suitable for the user based on a room impulse response selected as a preferable response for the user among the plurality of room impulse responses in the database obtained by listening of the user.

As another example, the generation unit 2313 generates a room impulse response by directly performing acoustic measurement using the positions of the sound producing points and the sound receiving points set by the setting unit 2312 and the room shape information by wearing microphones on the ears of the user or using a gun microphone. In a case where a gun microphone is used, the generation unit 2313 generates a room impulse response by installing a sound source such as a speaker at a position of the sound producing point, and causing a gun microphone installed at a position of a sound receiving point to acquire (receive) a sound such as a signal sound output from the sound source.

Hereinafter, an example of generation of a room impulse response by the generation unit 2313 will be described with reference to FIGS. 4 to 14. In the following example, for convenience, a case where the generation unit 2313 generates a room impulse response by performing an acoustic simulation will be mainly described.

However, in the following example, the generation unit 2313 may generate a room impulse response using a learned model in which a relationship between the positions of the sound producing points and the sound receiving points, the room shape information, and the room impulse response is learned, and the room impulse response is output when the positions of the sound producing points and the sound receiving points and the room shape information are input. The generation unit 2313 may generate a room impulse response using a database in which the positions of the sound producing points and the sound receiving points, the room shape information, and the room impulse response are associated with each other. In addition, the generation unit 2313 may generate a room impulse response by directly performing acoustic measurement, such as by wearing microphones on the ears of the user or using a gun microphone, by using the set positions of the sound producing points and the sound receiving points and the room shape information. In a case where a gun microphone is used, the generation unit 2313 generates a room impulse response by installing a sound source such as a speaker at the position such as sound producing point PP, and causing a gun microphone installed at the position of the sound receiving point RP to acquire a sound such as a signal sound output from the sound source.

First, an example of generation of a room impulse response by the generation unit 2313 will be described with reference to FIG. 4. The generation unit 2313 performs an acoustic simulation with each of the sound receiving points RP for each of the sound producing points PP based on distance information and angle information between the sound producing points PP set at the positions of the 5.1ch speaker arrangement and the sound receiving points RP set at the head related impulse response measurement positions and the room shape information R1. Subsequently, the generation unit 2313 generates a room impulse response based on the result of the acoustic simulation.

As is clear from the positions of the table, the sound producing points PP, and the sound receiving points RP in the room represented by the room shape information R1, a reflected sound structure from a front left sound producing point PP to a front left sound receiving point RP of the user is greatly different from a reflected sound structure from a front right sound producing point PP to a front right sound receiving point RP of the user. Therefore, the generation unit 2313 generates a room impulse response that includes the characteristic of the room environment represented by the room shape information R1 and to which a resonance of the sound of the space of the room in which the user himself/herself is listening is added. As a result, the generation unit 2313 can provide an effect of creating a virtual sound field space in the space of the room where the user himself/herself is present even though the user is listening through the headphones 30.

As illustrated in FIGS. 5 and 6, unlike the positions of the sound receiving points RP illustrated in FIG. 4, in a case where the positions of the sound receiving points RP are set in all directions of the user, the relationship between the sound producing points PP and the sound receiving points RP changes. The generation unit 2313 performs an acoustic simulation with each of the sound receiving points RP for each of the sound producing points PP based on the distance information and the angle information between the sound producing points PP and the sound receiving points RP at the positions illustrated in FIGS. 5 and 6 and the room shape information R1. Subsequently, the generation unit 2313 generates a room impulse response based on the result of the acoustic simulation.

In the example illustrated in FIG. 7, the generation unit 2313 performs an acoustic simulation with each of the sound receiving points RP for each of the sound producing points PP based on the distance information and the angle information between the sound producing points PP set at the positions of the 7.1ch speaker arrangement and the sound receiving points RP set at the head related impulse response measurement positions and the room shape information R1. Subsequently, the generation unit 2313 generates a room impulse response based on the result of the acoustic simulation.

In the example illustrated in FIGS. 8 and 9, the generation unit 2313 performs an acoustic simulation with each of the sound receiving points RP for each of the sound producing points PP and the sound producing points PPX based on the distance information and the angle information between the sound producing points PP and the sound producing points PPX set at the positions of the 7.1.4ch speaker arrangement and the sound receiving points RP set at the head related impulse response measurement positions and the room shape information R1. Subsequently, the generation unit 2313 generates a room impulse response based on the result of the acoustic simulation.

As illustrated in FIG. 10, unlike the positions of the sound receiving points RP illustrated in FIGS. 8 and 9, in a case where the positions of the sound receiving points RP are set in all directions of the user, the relationship between the sound producing points PP and the sound producing points PPX and the sound receiving points RP changes. The generation unit 2313 performs an acoustic simulation with each of the sound receiving points RP for each of the sound producing points PP and the sound producing points PPX based on the distance information and the angle information between the sound producing points PP and the sound producing points PPX and the sound receiving points RP at the positions illustrated in FIG. 10 and the room shape information R1. Subsequently, the generation unit 2313 generates a room impulse response based on the result of the acoustic simulation.

In the example illustrated in FIG. 11, the generation unit 2313 performs an acoustic simulation with each of the sound receiving points RP for each of the sound producing points PP based on the distance information and the angle information between the sound producing points PP set at the positions according to the content provided to the user together with the sound output from the virtual sound source and the sound receiving points RP set at the head related impulse response measurement positions and the room shape information R1. Subsequently, the generation unit 2313 generates a room impulse response based on the result of the acoustic simulation.

As illustrated in FIG. 12, unlike the positions of the sound receiving points RP illustrated in FIG. 11, in a case where the positions of the sound receiving points RP are set in all directions of the user, the relationship between the sound producing points PP and the sound receiving points RP changes. The generation unit 2313 performs an acoustic simulation with each of the sound receiving points RP for each of the sound producing points PP based on the distance information and the angle information between the sound producing points PP and the sound receiving points RP at the positions illustrated in FIG. 12 and the room shape information R1. Subsequently, the generation unit 2313 generates a room impulse response based on the result of the acoustic simulation.

As illustrated in FIG. 13, unlike the positions of the sound receiving points RP illustrated in FIG. 4, in a case where a position of only one sound receiving point RP is set, the relationship between the sound producing points PP and the sound receiving point RP changes. The generation unit 2313 performs an acoustic simulation with the sound receiving point RP for each of the sound producing points PP based on the distance information and the angle information between the sound producing points PP and the sound receiving point RP at the positions illustrated in FIG. 13 and the room shape information R1. Subsequently, the generation unit 2313 generates a room impulse response based on the result of the acoustic simulation.

As illustrated in FIG. 14, in a case where two sound receiving points RP are set, the generation unit 2313 performs an acoustic simulation with both sound receiving points RP for each of the sound producing points PP. Subsequently, the generation unit 2313 generates a room impulse response based on the result of the acoustic simulation. As a result, the generation unit 2313 can reproduce the virtual space with higher accuracy as compared with the case where one sound receiving point RP is set by the setting unit 2312 as illustrated in FIG. 13.

A restoration unit 2321 restores the head shape information to the head shape information in which the head of the user is three-dimensionally represented based on the head shape information acquired by the head shape information acquisition unit 222. For example, the restoration unit 2321 restores the head shape information including the head imaging information to the head shape information in which the ears of the user are three-dimensionally represented, such as reconstructing the head shape information to a three-dimensional model of the ears of the user, by a three-dimensional restoration technique such as LiDAR, photogrammetry, a 3 Dimensions (3D) scanner, or an ear type creation technique for generating a three-dimensional model of the ears.

A setting unit 2322 sets a position of a virtual sound source and positions of listening points based on the head shape information acquired by the head shape information acquisition unit 222. Hereinafter, an example of the setting of the positions of the sound source and the listening points by the setting unit 2322 will be described with reference to FIG. 15. FIG. 15 is a diagram illustrating an example of the setting of the positions of the sound source and the listening points. In this case, the setting unit 2322 sets the position of the sound producing point PP of the virtual sound source set by the setting unit 2312 in the room impulse response generation unit 231 as the position of the virtual sound source, and sets the positions of the ears of the user U as the positions of the listening points LP.

A generation unit 2323 generates a head related impulse response based on the sound source position information indicated by the position of the virtual sound source set by the setting unit 2322 and the head shape information. For example, the generation unit 2323 generates a head related impulse response by converting the sound source position information and the positions of the listening points set by the setting unit 2322, and the head shape information or the like, which is primary information serving as a source of the head related impulse response, into the head related impulse response and making the head related impulse response audible. Since the generation unit 2313 generates a room impulse response in consideration of the influence between the sound producing point PP and the sound receiving point RP in FIG. 15, the generation unit 2323 generates the head related impulse response that does not take into consideration this influence. That is, the generation unit 2323 generates a head related impulse response in consideration of an influence of a spherical region in a predetermined range from the user U illustrated in FIG. 15.

A method for generating the head related impulse response by the generation unit 2323 is not particularly limited as long as it is a method for generating the head related impulse response based on the sound source position information and the positions of the listening points set by the setting unit 2322, and the head shape information. The generation unit 2323 may generate the head related impulse response by: performing an acoustic simulation based on the sound source position information and the positions of the listening points set by the setting unit 2322 and the head shape information; using a second learned model in which a relationship between the sound source position information, the positions of the listening points, the head shape information, and the head related impulse response is learned, and the head related impulse response is output in a case where the sound source position information, the positions of the listening points, and the head shape information are input; using a second database in which the sound source position information, the positions of the listening points, the head shape information, and the head related impulse response are associated with each other; or directly performing acoustic measurement.

As an example, the generation unit 2323 generates a head related impulse response based on the result of the acoustic simulation by performing the acoustic simulation based on the sound source position information represented by the position of the virtual sound source in the room and the positions of the listening points set by the setting unit 2322 and the head shape information. In this case, for example, the generation unit 2323 generates a head related impulse response by generating a 3D model of the ears from the feature amount of the auricle and performing the acoustic simulation in a case where a signal sound is emitted with respect to a listening point in a head 3D model including the 3D model of the ears.

As an example, the generation unit 2323 inputs the sound source position information and the positions of the listening points set by the setting unit 2322 and the head shape information to the second learned model, and generates the response output from the second learned model as the head related impulse response.

As an example, the generation unit 2323 generates a head related impulse response by using a second database in which a plurality of pieces of sound source position information, the positions of the listening points, the head shape information, and a plurality of head related impulse responses are associated with each other. In this case, first, the generation unit 2323 generates a second database in which a plurality of pieces of sound source position information and the positions of the listening points set by the setting unit 2322, the head shape information, and a plurality of head related impulse responses are associated with each other. Next, the generation unit 2323 generates a head related impulse response based on feedback information from the user among the plurality of head related impulse responses in the second database obtained by listening of the user. For example, the generation unit 2323 generates a head related impulse response to be recommended that is suitable for the user based on a head related impulse response selected as a preferable response for the user from among the plurality of head related impulse responses in the second database obtained by listening of the user.

As an example, the generation unit 2323 generates a head related impulse response by wearing microphones on the ears of the user and directly performing acoustic measurement using the sound source position information and the positions of the listening points set by the setting unit 2322 and the head shape information.

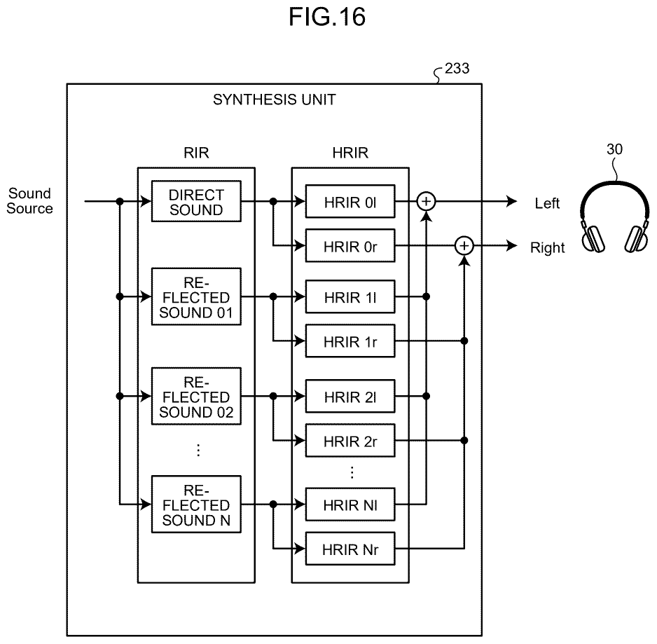

A synthesis unit 233 synthesizes the room impulse response generated by the generation unit 2313 in the room impulse response generation unit 231 and the head related impulse response generated by the generation unit 2323 in the head related impulse response generation unit 232 to generate a binaural room impulse response. Hereinafter, an example of the configuration of the synthesis unit 233 will be described with reference to FIG. 16. FIG. 16 is a diagram illustrating an example of a configuration of a synthesis unit.

The synthesis unit 233 synthesizes two head related impulse responses (HRIR) for each of a room impulse response (RIR) of a direct sound, a room impulse response of a reflected sound 01, a room impulse response of a reflected sound 02, . . . , and a room impulse response of a reflected sound N among the sounds output from the virtual sound source. For example, the synthesis unit 233 synthesizes the room impulse response of the direct sound with a head related impulse response HRIR0l and a head related impulse response HRIR0r, respectively. The synthesis unit 233 synthesizes the room impulse response of the reflected sound 01 with a head related impulse response HRIR1l and a head related impulse response HRIR1r, respectively. The synthesis unit 233 synthesizes the room impulse response of the reflected sound 02 with a head related impulse response HRIR2l and a head related impulse response HRIR2r, respectively. The synthesis unit 233 synthesizes the room impulse response of the reflected sound N with a head related impulse response HRIRNl and a head related impulse response HRIRNr, respectively.

The output unit 24 outputs the binaural room impulse response synthesized by the synthesis unit 233 to the headphones 30. For example, as illustrated in FIG. 2, the output unit 24 outputs the room impulse response and the head related impulse response synthesized by the synthesis unit 233 to the left and right (left and right) headphones 30.

The storage unit 25 stores various types of information such as room imaging information, room shape information, head imaging information, head shape information, reflectance information, width information, size information, a learned model, a second learned model, a database, a second database, a position of a sound producing point, a position of a sound receiving point, a position of a user, a room impulse response, and a head related impulse response. Examples of the storage unit 25 include a storage device such as an HDD, an SSD, and an optical disk, and a semiconductor memory capable of rewriting data such as a RAM, a flash memory, and an NVSRAM. The storage unit 25 stores an OS and various programs executed by the server 20.

The headphones 30 output the binaural room impulse response output from the output unit 24 to the left and right ears of the user. The headphones 30 may be arbitrary as long as they have this function.

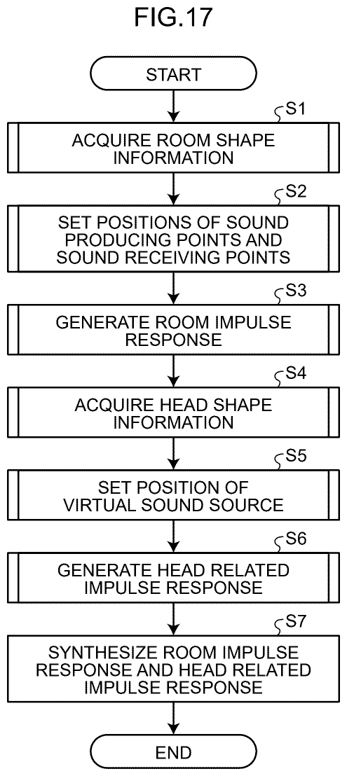

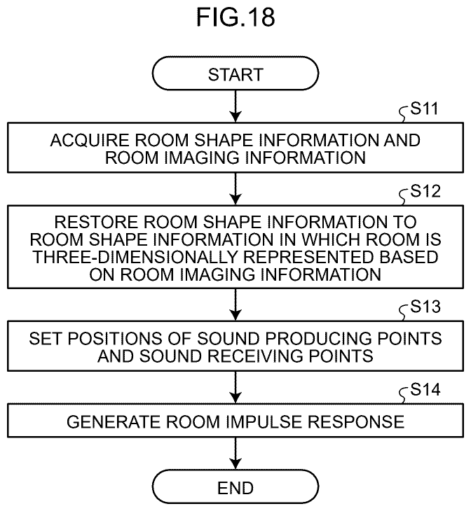

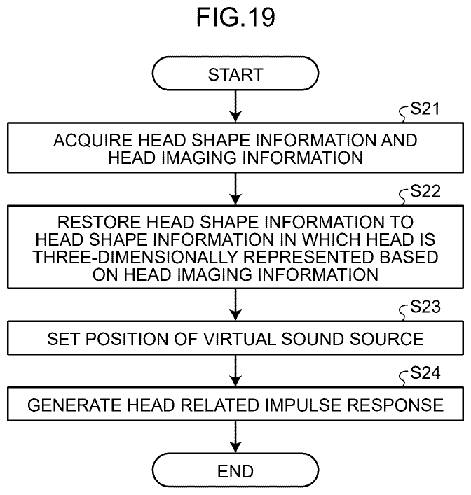

Next, a flow of each processing executed by the server 20 functioning as the generation device will be described with reference to FIGS. 17 to 19. FIG. 17 is a flowchart illustrating an example of room impulse response generation processing and head related impulse response generation processing. FIG. 18 is a flowchart illustrating an example of room impulse response generation processing. FIG. 19 is a flowchart illustrating an example of head related impulse response generation processing. First, flows of room impulse response generation processing and head related impulse response generation processing by the server 20 will be described with reference to FIG. 17.

In Step S1, the room shape information acquisition unit 221 acquires room shape information regarding a shape of a room. That is, the room shape information acquisition unit 221 acquires primary information serving as a source of the RIR.

In Step S2, the setting unit 2312 sets positions of sound producing points and sound receiving points of a virtual sound source based on the room shape information acquired by the room shape information acquisition unit 221.

In Step S3, the generation unit 2313 generates a room impulse response in the room based on the positions of the sound producing points and the sound receiving points set by the setting unit 2312 and the room shape information. That is, the generation unit 2313 converts the primary information serving as the source of the RIR into the RIR.

In Step S4, the head shape information acquisition unit 222 acquires head shape information. That is, the head shape information acquisition unit 222 acquires primary information serving as a source of the HRIR.

In Step S5, the setting unit 2322 sets a position of the virtual sound source based on the head shape information acquired by the head shape information acquisition unit 222. For example, the setting unit 2322 sets the position of the virtual sound source and the positions of the listening points based on the head shape information.

In Step S6, the generation unit 2323 generates a head related impulse response. That is, the generation unit 2323 converts the primary information serving as the source of the HRIR into the HRIR.

In Step S7, the synthesis unit 233 synthesizes the room impulse response generated by the generation unit 2313 with the head related impulse response generated by the generation unit 2323. That is, the synthesis unit 233 synthesis the RIR and the HRIR. As a result, the synthesis unit 233 generates the BRIR.

Next, the flow of the room impulse response generation processing corresponding to Steps S1 to S4 in FIG. 17 will be described in more detail with reference to FIG. 18.

In Step S11, the room shape information acquisition unit 221 acquires room shape information and room imaging information. For example, the room shape information acquisition unit 221 acquires, as the room shape information, room imaging information obtained by imaging a room environment of a user by the imaging unit 11 such as a camera.

In Step S12, the restoration unit 2311 restores the room shape information to the room shape information in which the room is three-dimensionally represented based on the room imaging information acquired by the room shape information acquisition unit 221. For example, the restoration unit 2311 restores the room imaging information to the room shape information in which the room is three-dimensionally represented by a three-dimensional restoration technique.

In Step S13, the setting unit 2312 sets positions of sound producing points and sound receiving points of the virtual sound source in the room based on the room shape information restored to the room shape information three-dimensionally represented by the restoration unit 2311.

In Step S14, the generation unit 2313 generates a room impulse response based on the positions of the sound producing points and the sound receiving points set by the setting unit 2312 and the room shape information.

For example, the generation unit 2313 generates a room impulse response by: performing an acoustic simulation based on the positions of the sound producing points and the sound receiving points set by the setting unit 2312 and the room shape information; using a learned model in which a relationship between the positions of the sound producing points and the sound receiving points, the room shape information, and the room impulse response is learned, and the room impulse response is output in a case where the positions of the sound producing points and the sound receiving points and the room shape information are input; using a database in which the positions of the sound producing points and the sound receiving points, the room shape information, and the room impulse response are associated with each other; or directly performing acoustic measurement.

As an example, the generation unit 2313 generates a room impulse response based on the result of the acoustic simulation by performing the acoustic simulation based on the positions of the sound producing points and the sound receiving points set by the setting unit 2312 and the room shape information.

As an example, the generation unit 2313 inputs the positions of the sound producing points and the sound receiving points set by the setting unit 2312 and the room shape information to a learned model in which the relationship between the positions of the sound producing points and the sound receiving points, the room shape information, and the room impulse response is learned, and the room impulse response is output in a case where the positions of the sound producing points and the sound receiving points and the room shape information are input, and generates the response output from the learned model as the room impulse response.

As an example, the generation unit 2313 generates a room impulse response by using a database in which positions of a plurality of sound producing points and sound receiving points set by the setting unit 2312, the room shape information, and a plurality of room impulse responses are associated with each other. In this case, first, the generation unit 2313 generates a database in which the positions of the plurality of sound producing points and sound receiving points set by the setting unit 2312, the room shape information, and the plurality of impulse responses are associated with each other. Next, the generation unit 2313 generates a room impulse response based on feedback information from the user among the plurality of room impulse responses in the database obtained by listening of the user. For example, the generation unit 2313 generates a room impulse response to be recommended that is suitable for the user based on a room impulse response selected as a preferable response for the user among the plurality of room impulse responses in the database obtained by listening of the user.

As an example, the generation unit 2313 generates a room impulse response by directly performing acoustic measurement using the positions of the sound producing points and the sound receiving points set by the setting unit 2312 and the room shape information by wearing microphones on the ears of the user or using a gun microphone. In a case where a gun microphone is used, the generation unit 2313 generates a room impulse response by installing a sound source such as a speaker at a position such as a sound producing point, and causing a gun microphone installed at a position of a sound receiving point to acquire a sound such as a signal sound output from the sound source.

Next, the flow of the head related impulse response generation processing corresponding to Steps S5 and S6 in FIG. 17 will be described in more detail with reference to FIG. 19.

In Step S21, the head shape information acquisition unit 222 acquires head shape information and head imaging information. For example, the head shape information acquisition unit 222 acquires, as the head shape information, head imaging information in which the head including the ears of the user is imaged by the imaging unit 11 such as a camera.

In Step S22, the restoration unit 2321 restores the head shape information to the head shape information in which the head of the user is three-dimensionally represented based on the head imaging information acquired by the head shape information acquisition unit 222. For example, the restoration unit 2321 restores the head imaging information to the head shape information in which the ears of the user are three-dimensionally represented, such as reconstructing the head imaging information to a three-dimensional model of the ears of the user, by a three-dimensional restoration technique such as LiDAR, photogrammetry, a 3D scanner, or an ear type creation technique for generating a three-dimensional model of the ears.

In Step S23, the setting unit 2322 sets a position of the virtual sound source in the room based on the head shape information restored to the head shape information three-dimensionally represented by the restoration unit 2321. For example, the setting unit 2322 sets the position of the virtual sound source and the positions of the listening points based on the head shape information.

In Step S24, the generation unit 2323 generates a head related impulse response based on the sound source position information represented by the position of the virtual sound source in the room set by the setting unit 2322 and the head shape information.

For example, the generation unit 2323 generates a head related impulse response by: performing an acoustic simulation based on the sound source position information and the positions of the listening points set by the setting unit 2322 and the head shape information; using a second learned model in which the relationship between the sound source position information, the positions of the listening points, the head shape information, and the head related impulse response is learned, and the head related impulse response is output in a case where the sound source position information, the positions of the listening points, and the head shape information are input; using a second database in which the sound source position information, the positions of the listening points, the head shape information, and the head related impulse response are associated with each other; or directly performing acoustic measurement.

As an example, the generation unit 2323 generates a head related impulse response based on the result of the acoustic simulation by performing the acoustic simulation based on the sound source position information represented by the position of the virtual sound source in the room and the positions of the listening points set by the setting unit 2322 and the head shape information. In this case, for example, the generation unit 2323 generates a head related impulse response by generating a 3D model of the ears from the feature amount of the auricle and performing the acoustic simulation in a case where a signal sound is emitted with respect to a listening point in a head 3D model including the 3D model of the ears.

As an example, the generation unit 2323 inputs the sound source position information and the positions of the listening points set by the setting unit 2322 and the head shape information to the second learned model, and generates the response output from the second learned model as the head related impulse response.

As an example, the generation unit 2323 generates a head related impulse response by using a second database in which a plurality of pieces of sound source position information, the positions of the listening points, the head shape information, and a plurality of head related impulse responses are associated with each other. In this case, first, the generation unit 2323 generates a second database in which a plurality of pieces of sound source position information and the positions of the listening points set by the setting unit 2322, the head shape information, and a plurality of head related impulse responses are associated with each other. Next, the generation unit 2323 generates a head related impulse response based on feedback information from the user among the plurality of head related impulse responses in the second database obtained by listening of the user. For example, the generation unit 2323 generates a head related impulse response to be recommended that is suitable for the user based on a head related impulse response selected as a preferable response for the user from among the plurality of head related impulse responses in the second database obtained by listening of the user.

As an example, the generation unit 2323 generates a head related impulse response by wearing microphones on the ears of the user and directly performing acoustic measurement using the sound source position information and the positions of the listening points set by the setting unit 2322 and the head shape information.

### 2. Modification

In the above-described example, the generation system 1 includes the terminal 10 and the server 20, but may include at least one of the headphones 30, a head-mounted display, and an earphone instead of or in addition to the terminal 10 and the server 20. That is, the generation device included in the generation system 1 may be at least one of the server 20, the terminal 10, the headphones 30, the head-mounted display, and the earphone. Furthermore, the generation device may be another device as long as the generation device can execute series of processing from the room imaging processing to the room impulse response generation processing.

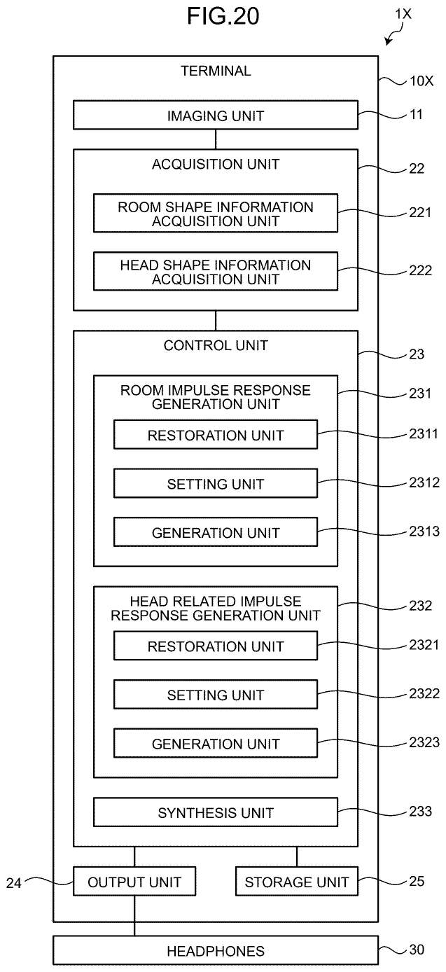

Hereinafter, an example of a schematic configuration of a generation system 1X according to a modification will be described with reference to FIG. 20. FIG. 20 is a diagram illustrating an example of the schematic configuration of the generation system according to the modification. In the example illustrated in FIG. 20, the generation system 1X includes a terminal 10X that functions as a generation device instead of the terminal 10 and the server 20. In the example illustrated in FIG. 20, the terminal 10X further includes an acquisition unit 22 and an output unit 24, and includes a control unit 23 and a storage unit 25 in which a learned model and the like are further stored instead of the control unit 13 and the storage unit 12 in the embodiment. Except for this point, the terminal 10X is similar to the terminal 10 in the embodiment. The control unit 23 further includes a room impulse response generation unit 231 for performing room impulse response generation processing, a head related impulse response generation unit 232 for performing head related impulse response generation processing, and a synthesis unit 233. Other than this point, the control unit 23 is similar to the control unit 13 in the embodiment.

As described above, the terminal 10X further includes each unit of the server 20 for performing the room impulse response generation processing and the like, and executes series of processing from the room imaging processing to the room impulse response generation processing only by the terminal 10X. For example, the generation unit 2313 of the terminal 10X generates a room impulse response by using a learned model in which a relationship between the positions of the sound producing points and the sound receiving points, the room shape information, and the room impulse response is learned, and the room impulse response is output in a case where the positions of the sound producing points and the sound receiving points and the room shape information are input. As an example, the generation unit 2313 of the terminal 10X inputs the positions of the sound producing points and the sound receiving points set by the setting unit 2312 and the room shape information to the learned model, and generates the response output from the learned model as the room impulse response.

Furthermore, the terminal 10X further includes each unit of the server 20 for performing head related impulse response generation processing and the like, and executes series of processing from the head imaging processing to the head related impulse response generation processing only by the terminal 10X. For example, the generation unit 2323 of the terminal 10X generates a head related impulse response by using a second learned model in which a relationship between the sound source position information, the positions of the listening points, the head shape information, and the head related impulse response is learned, and the head related impulse response is output in a case where the sound source position information, the positions of the listening points, and the head shape information are input. As an example, the generation unit 2323 of the terminal 10X inputs the sound source position information and the positions of the listening points set by the setting unit 2322 and the head shape information to the second learned model, and generates the response output from the second learned model as the head related impulse response.

As described above, the respective units for generating the room impulse response and the head related impulse response, such as the acquisition unit 22, the room impulse response generation unit 231, the head related impulse response generation unit 232, and the synthesis unit 233, are not included in the server 20, and may be included in the terminal 10X such as a smartphone. Even in this case, the terminal 10X can generate the room impulse response and the head related impulse response similarly to the server 20 by using, for example, the learned model and the second learned model.

Furthermore, in the above-described example, the terminal 10X includes respective units for generating the room impulse response and the head related impulse response, such as the room impulse response generation unit 231, the head related impulse response generation unit 232, and the synthesis unit 233. However, instead of or in addition to the terminal 10X, at least one of the headphones 30, the head-mounted display, the earphone, and another device may have at least one of these units. In this case, each of the headphones 30, the head-mounted display, the earphone, and another device may include all of the above-described units, or may include a part of each of the above-described units. Also in this case, similarly to the terminal 10X, the headphones 30, the head-mounted display, the earphone, and another device can generate the room impulse response and the head related impulse response similarly to the server 20 by using, for example, the learned model and the second learned model.

### 3. Example of Hardware Configuration

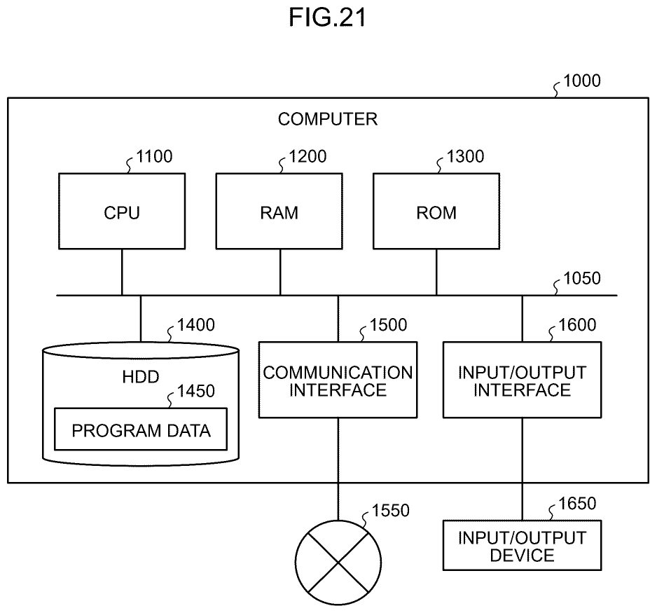

Various devices such as the terminal 10 and the server 20 described above can include a computer. An example will be described with reference to FIG. 21.

FIG. 21 is a diagram illustrating an example of a hardware configuration of the device. The exemplified computer 1000 includes a CPU 1100, a RAM 1200, a read only memory (ROM) 1300, an HDD 1400, a communication interface 1500, and an input/output interface 1600. Each unit of the computer 1000 is coupled by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program that depends on hardware of the computer 1000, and the like.

The HDD 1400 is a computer-readable recording medium that non-transiently records a program executed by the CPU 1100, data used by the program, and the like. Specifically, the HDD 1400 is a recording medium that records a generation program for executing each operation according to the present disclosure which is an example of program data 1450.

The communication interface 1500 is an interface for the computer 1000 to couple to an external network 1550 (for example, the Internet). For example, the CPU 1100 receives data from another equipment or transmits data generated by the CPU 1100 to another equipment via the communication interface 1500.

The input/output interface 1600 is an interface for coupling an input/output device 1650 to the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Further, the input/output interface 1600 may function as a media interface that reads a program or the like recorded in a predetermined recording medium (medium). The medium is an optical recording medium such as a digital versatile disc (DVD) and a phase change rewritable disk (PD), a magneto-optical recording medium such as a magneto-optical disk (MO), a tape medium, a magnetic recording medium, a semiconductor memory, or the like.

At least a part of the functions of the terminal 10 and the server 20 described above may be realized, for example, by the CPU 1100 of the computer 1000 executing a program loaded on the RAM 1200. In addition, the HDD 1400 stores a program and the like according to the present disclosure. Note that the CPU 1100 reads the program data 1450 from the HDD 1400 and executes the program data, but as another example, these programs may be acquired from another device via the external network 1550.

### 4. Example of Effects

The technique described above is specified as follows, for example. One of the disclosed techniques is a generation device (the server 20 and the terminal 10X). As described with reference to FIGS. 1 to 20 and the like, the generation device includes the room shape information acquisition unit 221 that acquires the room shape information regarding the shape of the room, the setting unit 2312 that sets the positions of the sound producing points and the sound receiving points of the virtual sound source in the room based on the room shape information acquired by the room shape information acquisition unit 221, and the generation unit 2313 that generates the room impulse response in the room based on the positions of the sound producing points and the sound receiving points set by the setting unit 2312 and the room shape information.

The above-described generation device acquires room shape information which is information regarding an environment in which a user listens to a sound, in consideration of a room which is the environment in which the user actually listens to the sound, and sound producing points and sound receiving points, and generates a transfer function called a room impulse response personalized for the user based on the acquired information. For example, the generation device captures the room shape information, the sound producing points, and the sound receiving points, performs an acoustic simulation or the like based on the captured information, and adds the captured information to the parameter for binaural signal processing, thereby converting the captured information into the room impulse response.

As a result, the generation device can eliminate the difference between a space of the room where the user exists and a space provided through the output device such as the headphones 30 and add a sound of the environment where the user exists. That is, according to the generation device, it is possible to enhance the effect of replacing the room impulse response with a response suitable for the environment in which the user actually listens to the sound. Therefore, according to the generation device, it is possible to reproduce the virtual sound source in consideration of the environment in which the user actually listens to the sound.

For example, in a case where a stereophonic sound of a movie or a game is reproduced using the headphones 30, the generation device can enhance a sense of localization of the sound by generating a head related impulse response using data of the head of the user himself/herself or the like. In addition, the generation device generates the room impulse response, and can add a resonance of the sound of the space of the room in which the user himself/herself listens to the sound as a resonance in the specific room, rather than the parameter provided as a fixed value as in the past. As a result, the generation device can provide an effect as if a virtual sound field space is created in the space of the room where the user himself/herself exists even though the user is listening through the headphones 30.

As described with reference to FIGS. 1 to 20 and the like, the room shape information acquisition unit 221 may acquire the room shape information in which the room is three-dimensionally represented. As a result, it is possible to generate a room impulse response and reproduce a virtual sound source in more consideration of the environment in which the user actually listens to the sound, as compared with a case where the room impulse response is generated and the virtual sound source is reproduced based on the room shape information in which the room is two-dimensionally represented.

As described with reference to FIGS. 1 to 20 and the like, the room shape information acquisition unit 221 may further acquire the room imaging information obtained by imaging the room, and the restoration unit 2311 that restores the room shape information to the room shape information in which the room is three-dimensionally represented based on the room imaging information acquired by the room shape information acquisition unit 221 may be further included. As a result, only by causing the user to image the room, the generation device can restore to the room shape information in which the room is three-dimensionally represented from the room imaging information, and can generate the room impulse response and reproduce the virtual sound source in more consideration of the environment in which the user actually listens to the sound, as compared with a case where the generation of the room impulse response and the reproduction of the virtual sound source are performed based on the room shape information in which the room is two-dimensionally represented.

As described with reference to FIGS. 1 to 20 and the like, the room shape information acquisition unit 221 may acquire the room shape information in which the room is represented as a plan view. The generation device enables the generation of the room impulse response and the reproduction of the virtual sound source in consideration of the environment in which the user actually listens to the sound based on the reflectance information between the room and the exterior or the like represented by the room shape information in which the room is represented as a plan view while suppressing cost for three-dimensionally restoring the room shape information.

As described with reference to FIGS. 1 to 20 and the like, the room shape information acquisition unit 221 may further acquire at least one of the reflectance information regarding the reflectance of the boundary between the room and the exterior, the width information regarding the width of the room, and the size information regarding the size of the body of the user, and the generation unit 2313 may generate the room impulse response further based on the information acquired by the room shape information acquisition unit 221 among the reflectance information, the width information, and the size information. As a result, since the room impulse response is generated in consideration of the reflectance information, it is possible to generate the room impulse response and reproduce the virtual sound source in more consideration of the environment in which the user actually listens to the sound.

As described with reference to FIGS. 1 to 20 and the like, the room shape information acquisition unit 221 may acquire the reflectance information including the material information regarding the material of the room. Since the reflectance of the room changes depending on whether the material of the room is specular or carpet, the generation of the room impulse response in consideration of the reflectance information including the material information enables the generation of the room impulse response and the reproduction of the virtual sound source in more consideration of the environment in which the user actually listens to the sound.

As described with reference to FIGS. 1 to 20 and the like, the setting unit 2312 may further set the directivity of the sound output from the virtual sound source, and the generation unit 2313 may generate the room impulse response further based on the directivity set by the setting unit 2312. As a result, since the room impulse response in consideration of the directivity of the sound is generated, it is possible to generate the room impulse response and reproduce the virtual sound source in more consideration of the environment in which the user actually listens to the sound.

As described with reference to FIGS. 1 to 20 and the like, the setting unit 2312 may further set the distance attenuation rate of the sound output from the virtual sound source, and the generation unit 2313 may generate the room impulse response further based on the distance attenuation rate set by the setting unit 2312. As a result, since the room impulse response in consideration of the distance attenuation rate is generated, it is possible to generate the room impulse response and reproduce the virtual sound source in more consideration of the environment in which the user actually listens to the sound.

As described with reference to FIGS. 1 to 20 and the like, the setting unit 2312 may further set the position of the user, and the generation unit 2313 may generate the room impulse response further based on the position of the user set by the setting unit 2312. As a result, since the room impulse response in consideration of the position of the user is generated, it is possible to generate the room impulse response and reproduce the virtual sound source in more consideration of the environment in which the user actually listens to the sound.

As described with reference to FIGS. 1 to 20 and the like, the setting unit 2312 may set the positions of the sound producing points so as to achieve a 5.1ch speaker arrangement. As a result, it is possible to reproduce the virtual sound source in consideration of the environment in which the user listens to the sound of the 5.1ch speaker.

As described with reference to FIGS. 1 to 20 and the like, the setting unit 2312 may set the positions of the sound producing points so as to achieve a 7.1ch speaker arrangement. As a result, it is possible to reproduce the virtual sound source in consideration of the environment in which the user listens to the sound of the 7.1ch speaker.

As described with reference to FIGS. 1 to 20 and the like, the setting unit 2312 may set the positions of the sound producing points so as to achieve a 7.1.4ch speaker arrangement. As a result, it is possible to reproduce the virtual sound source in consideration of the environment in which the user listens to the sound of the 7.1.4ch speaker.

As described with reference to FIGS. 1 to 20 and the like, the setting unit 2312 may set the positions of the sound receiving points at the head related impulse response measurement positions corresponding to the positions where the head related impulse response of the user is measured in an anechoic chamber. This makes it possible to reproduce the virtual sound source in consideration of the head related impulse response. In addition, the room impulse response and the head related impulse response can be easily synthesized.

As described with reference to FIGS. 1 to 20 and the like, the setting unit 2312 may set the positions of the sound receiving points in all directions of the user. As a result, the generation device can perform an acoustic simulation based on the sound receiving points set at spherical positions in all directions of the user, for example, and make the user listen to the sound having a stereoscopic effect.

As described with reference to FIGS. 1 to 20 and the like, the setting unit 2312 may set the positions of the sound receiving points such that the density of the sound receiving points is equal to or higher than the predetermined density. As a result, the generation device can perform an acoustic simulation based on a large number of sound receiving points set at the spherical positions in all directions of the user, for example, and can make the user listen to the sound having a more stereoscopic effect.

As described with reference to FIGS. 1 to 20 and the like, the setting unit 2312 may set the positions of the sound producing points at the positions according to the content provided to the user together with the sound output from the virtual sound source. As a result, for example, it is possible to reproduce the virtual sound source according to the content, such as a virtual sound source in which a sound of an ally character near the user is output from near the user, a sound of an enemy character is output from behind the user, and a sound of a wave is output from a position away from the user.

As described with reference to FIGS. 1 to 20 and the like, the generation device may be at least one of the server 20, the terminal 10X, the headphones 30, the head-mounted display, and the earphone. The generation device can execute series of processing from the room imaging processing to the room impulse response generation processing by using any of these. In particular, in a case where the generation device is the server 20, since the processing capability and the processing speed are excellent, it is possible to more efficiently perform each processing such as room impulse response generation processing.

As described with reference to FIGS. 1 to 20 and the like, the generation unit 2313 may generate the room impulse response by, based on the positions of the sound producing points and the sound receiving points set by the setting unit 2312 and the room shape information, performing an acoustic simulation; using a learned model in which the relationship between the positions of the sound producing points and the sound receiving points, the room shape information, and the room impulse response is learned, and the room impulse response is output in a case where the positions of the sound producing points and the sound receiving points and the room shape information are input; using a database in which the positions of the sound producing points and the sound receiving points, the room shape information, and the room impulse response are associated with each other; or directly performing acoustic measurement. The generation unit 2313 enables generation of a room impulse response capable of reproducing a virtual sound source in consideration of an environment in which the user actually listens to the sound by any of the above-described methods.

The generation method described with reference to FIGS. 1 to 20 and the like is also one of the disclosed techniques. A generation method is a generation method executed by a generation device, the generation method including: an acquisition step of acquiring room shape information regarding a shape of a room (Steps S1 and S11); a setting step of setting positions of sound producing points and sound receiving points of a virtual sound source in the room based on the room shape information acquired in the acquisition step (Steps S2 and S13); and a generation step of generating a room impulse response in the room based on the positions of the sound producing points and the sound receiving points set in the setting step and the room shape information (Steps S3 and S14). Also by such a generation method, as described above, it is possible to reproduce the virtual sound source in consideration of the environment in which the user actually listens to the sound.

The generation program described with reference to FIGS. 1 to 21 and the like is also one of the disclosed techniques. The generation program causes a computer 1000 mounted on a server 20 to execute: acquisition processing of acquiring room shape information regarding a shape of a room; setting processing of setting positions of sound producing points and sound receiving points of a virtual sound source in the room based on the room shape information acquired by the acquisition processing; and generation processing of generating a room impulse response in the room based on the positions of the sound producing points and the sound receiving points set by the setting processing and the room shape information. Also with such a generation program, as described above, it is possible to reproduce the virtual sound source in consideration of the environment in which the user actually listens to the sound.

The effects described in the present disclosure are merely examples, and are not limited to the disclosed contents. There may be other effects.

Although the embodiment of the present disclosure has been described above, the technical scope of the present disclosure is not limited to the above-described embodiment as it is, and various modifications can be made without departing from the gist of the present disclosure, and different components in the modifications may be appropriately combined. For example, the generation device according to one aspect of the present disclosure may be a server, a terminal, headphones, a head-mounted display, an earphone, or another device. That is, series of processing from the room imaging processing to the room impulse response generation processing described in the above-described embodiment may be executed by any of a server, a terminal, headphones, a head-mounted display, an earphone, and another device.

Note that the present technique can be related to goal 9 “industry, innovation, infrastructure” of the sustainable development goals (SDGs) adopted at the UN summit in 2015.

Note that the present technique can also have the following configurations.
(1)

A generation device, including:
an acquisition unit configured to acquire room shape information regarding a shape of a room;
a setting unit configured to set positions of sound producing points and sound receiving points of a virtual sound source in the room based on the room shape information acquired by the acquisition unit; and
a generation unit configured to generate a room impulse response in the room based on the positions of the sound producing points and the sound receiving points set by the setting unit and the room shape information.
(2)

The generation device according to (1), wherein
the acquisition unit acquires the room shape information in which the room is three-dimensionally represented.
(3)

The generation device according to (1) or (2), wherein
the acquisition unit further acquires room imaging information obtained by imaging the room, and
the generation device further includes a restoration unit configured to restore the room shape information to the room shape information in which the room is three-dimensionally represented based on the room imaging information acquired by the acquisition unit.
(4)

The generation device according to any one of (1) to (3), wherein
the acquisition unit acquires the room shape information in which the room is represented as a plan view.
(5)

The generation device according to any one of (1) to (4), wherein
the acquisition unit further acquires at least one of reflectance information regarding a reflectance of a boundary between the room and an exterior, width information regarding a width of the room, and size information regarding a size of a body of a user, and
the generation unit generates the room impulse response further based on information acquired by the acquisition unit among the reflectance information, the width information, and the size information.
(6)

The generation device according to (4), wherein
the acquisition unit acquires the reflectance information including material information regarding a material of the room.
(7)

The generation device according to any one of (1) to (6), wherein
the setting unit further sets directivity of a sound output from the virtual sound source, and
the generation unit generates the room impulse response further based on the directivity set by the setting unit.
(8)

The generation device according to any one of (1) to (7), wherein
the setting unit further sets a distance attenuation rate of a sound output from the virtual sound source, and
the generation unit generates the room impulse response further based on the distance attenuation rate set by the setting unit.
(9)

The generation device according to any one of (1) to (8), wherein
the setting unit further sets a position of a user, and
the generation unit generates the room impulse response further based on the position of the user set by the setting unit.
(10)

The generation device according to any one of (1) to (9), wherein
the setting unit sets the positions of the sound producing points so as to achieve a 5.1ch speaker arrangement.
(11)

The generation device according to any one of (1) to (9), wherein
the setting unit sets the positions of the sound producing points so as to achieve a 7.1ch speaker arrangement.
(12)

The generation device according to any one of (1) to (9), wherein
the setting unit sets the positions of the sound producing points so as to achieve a 7.1.4ch speaker arrangement.
(13)

The generation device according to any one of (1) to (12), wherein
the setting unit sets the positions of the sound receiving points at head related impulse response measurement positions corresponding to positions at which a head related impulse response of a user is measured in an anechoic chamber.
(14)

The generation device according to any one of (1) to (13), wherein
the setting unit sets the positions of the sound receiving points in all directions of a user.
(15)

The generation device according to (14), wherein
the setting unit sets the positions of the sound receiving points such that a density of the sound receiving points is equal to or higher than a predetermined density.
(16)

The generation device according to any one of (1) to (9), wherein
the setting unit sets the positions of the sound producing points at positions according to a content provided to a user together with a sound output from the virtual sound source.
(17)

The generation device according to any one of (1) to (16), wherein
the generation device is at least one of a server, a terminal, headphones, a head-mounted display, and an earphone.
(18)

The generation device according to any one of (1) to (17), wherein
the generation unit generates the room impulse response by performing;
an acoustic simulation based on the positions of the sound producing points and the sound receiving points set by the setting unit and the room shape information,
using a learned model in which a relationship between the positions of the sound producing points and the sound receiving points, the room shape information, and the room impulse response is learned, and the room impulse response is output in a case where the positions of the sound producing points and the sound receiving points and the room shape information are input,
using a database in which the positions of the sound producing points and the sound receiving points, the room shape information, and the room impulse response are associated with each other, or
directly performing acoustic measurement.
(19)

A generation method executed by a generation device, the generation method including:
an acquisition step of acquiring room shape information regarding a shape of a room;
a setting step of setting positions of sound producing points and sound receiving points of a virtual sound source in the room based on the room shape information acquired in the acquisition step; and
a generation step of generating a room impulse response in the room based on the positions of the sound producing points and the sound receiving points set in the setting step and the room shape information.
(20)

A generation program for causing a computer mounted on a generation device to execute:
acquisition processing of acquiring room shape information regarding a shape of a room;
setting processing of setting positions of sound producing points and sound receiving points of a virtual sound source in the room based on the room shape information acquired by the acquisition processing; and
generation processing of generating a room impulse response in the room based on the positions of the sound producing points and the sound receiving points set by the setting processing and the room shape information.

### REFERENCE SIGNS LIST

1 GENERATION SYSTEM
10 TERMINAL
11 IMAGING UNIT
12, 25 STORAGE UNIT
13, 23 CONTROL UNIT
14, 21 COMMUNICATION UNIT
20 SERVER
22 ACQUISITION UNIT
24 OUTPUT UNIT
30 HEADPHONES
221 ROOM SHAPE INFORMATION ACQUISITION UNIT
222 HEAD SHAPE INFORMATION ACQUISITION UNIT
231 ROOM IMPULSE RESPONSE GENERATION UNIT
232 HEAD RELATED IMPULSE RESPONSE GENERATION UNIT
233 SYNTHESIS UNIT
2311, 2321 RESTORATION UNIT
2312, 2322 SETTING UNIT
2313, 2323 GENERATION UNIT

1. A generation device, including:
an acquisition unit configured to acquire room shape information regarding a shape of a room;
a setting unit configured to set positions of sound producing points and sound receiving points of a virtual sound source in the room based on the room shape information acquired by the acquisition unit; and
a generation unit configured to generate a room impulse response in the room based on the positions of the sound producing points and the sound receiving points set by the setting unit and the room shape information.

2. The generation device according to claim 1, wherein
the acquisition unit acquires the room shape information in which the room is three-dimensionally represented.

3. The generation device according to claim 1, wherein
the acquisition unit further acquires room imaging information obtained by imaging the room, and
the generation device further includes a restoration unit configured to restore the room shape information to the room shape information in which the room is three-dimensionally represented based on the room imaging information acquired by the acquisition unit.

4. The generation device according to claim 1, wherein
the acquisition unit acquires the room shape information in which the room is represented as a plan view.

5. The generation device according to claim 1, wherein
the acquisition unit further acquires at least one of reflectance information regarding a reflectance of a boundary between the room and an exterior, width information regarding a width of the room, and size information regarding a size of a body of a user, and
the generation unit generates the room impulse response further based on information acquired by the acquisition unit among the reflectance information, the width information, and the size information.

6. The generation device according to claim 5, wherein
the acquisition unit acquires the reflectance information including material information regarding a material of the room.

7. The generation device according to claim 1, wherein
the setting unit further sets directivity of a sound output from the virtual sound source, and
the generation unit generates the room impulse response further based on the directivity set by the setting unit.

8. The generation device according to claim 1, wherein
the setting unit further sets a distance attenuation rate of a sound output from the virtual sound source, and
the generation unit generates the room impulse response further based on the distance attenuation rate set by the setting unit.

9. The generation device according to claim 1, wherein
the setting unit further sets a position of a user, and
the generation unit generates the room impulse response further based on the position of the user set by the setting unit.

10. The generation device according to claim 1, wherein
the setting unit sets the positions of the sound producing points so as to achieve a 5.1ch speaker arrangement.

11. The generation device according to claim 1, wherein
the setting unit sets the positions of the sound producing points so as to achieve a 7.1ch speaker arrangement.

12. The generation device according to claim 1, wherein
the setting unit sets the positions of the sound producing points so as to achieve a 7.1.4ch speaker arrangement.

13. The generation device according to claim 1, wherein
the setting unit sets the positions of the sound receiving points at head related impulse response measurement positions corresponding to positions at which a head related impulse response of a user is measured in an anechoic chamber.

14. The generation device according to claim 1, wherein
the setting unit sets the positions of the sound receiving points in all directions of a user.

15. The generation device according to claim 14, wherein
the setting unit sets the positions of the sound receiving points such that a density of the sound receiving points is equal to or higher than a predetermined density.

16. The generation device according to claim 1, wherein
the setting unit sets the positions of the sound producing points at positions according to a content provided to a user together with a sound output from the virtual sound source.

17. The generation device according to claim 1, wherein
the generation device is at least one of a server, a terminal, headphones, a head-mounted display, and an earphone.

18. The generation device according to claim 1, wherein
the generation unit generates the room impulse response by performing:
an acoustic simulation based on the positions of the sound producing points and the sound receiving points set by the setting unit and the room shape information,
using a learned model in which a relationship between the positions of the sound producing points and the sound receiving points, the room shape information, and the room impulse response is learned, and the room impulse response is output in a case where the positions of the sound producing points and the sound receiving points and the room shape information are input,
using a database in which the positions of the sound producing points and the sound receiving points, the room shape information, and the room impulse response are associated with each other, or
directly performing acoustic measurement.

19. A generation method executed by a generation device, the generation method including:
an acquisition step of acquiring room shape information regarding a shape of a room;
a setting step of setting positions of sound producing points and sound receiving points of a virtual sound source in the room based on the room shape information acquired in the acquisition step; and
a generation step of generating a room impulse response in the room based on the positions of the sound producing points and the sound receiving points set in the setting step and the room shape information.

20. A generation program for causing a computer mounted on a generation device to execute:
acquisition processing of acquiring room shape information regarding a shape of a room;
setting processing of setting positions of sound producing points and sound receiving points of a virtual sound source in the room based on the room shape information acquired by the acquisition processing; and
generation processing of generating a room impulse response in the room based on the positions of the sound producing points and the sound receiving points set by the setting processing and the room shape information.
